(19) United States
(12) Patent Application Publication
(10) Pub. No.: US 2025/0168922 A1
(43) Pub. Date: May 22, 2025

(54) METHODS AND DEVICES FOR MANAGING CONFIGURATION OF DISCONTINUOUS RECEPTION FOR USER EQUIPMENT

(71) Applicant: Sony Group Corporation, Tokyo (JP)

(72) Inventors: Basuki PRIYANTO, Lund (SE); Nafiseh Seyed MAZLOUM, Lund (SE); Torgny PALENIUS, Barsebäck (SE); Anders BERGGREN, Lund (SE)

(21) Appl. No.: 18/835,086

(22) PCT Filed: Jan. 17, 2023
(86) PCT No.: PCT/EP2023/051017

§ 371 Date: Aug. 1, 2024

(30) Foreign Application Priority Data
Feb. 16, 2022 (SE) 2250161-3

(51) Int. Cl. H04W 76/28; H04L 47/24; H04W 72/232

(52) U.S. Cl. CPC H04W 76/28; H04L 47/24; H04W 72/232

(57) ABSTRACT

Method carried out in an access node of a wireless network for managing configuration of discontinuous reception, DRX, for a user equipment, UE, wherein the method comprises: transmitting, to the UE, radio configuration information for a plurality of different DRX configurations; obtaining traffic information indicative of data traffic intended for the UE; transmitting, to the UE, an indication of a determined DRX configuration, identifying at least one of said plurality of different DRX configurations based on the traffic information; conveying the data traffic to the UE based on the determined DRX configuration.

### TECHNICAL FIELD

This disclosure is related to wireless communication between a wireless device and a wireless network. Specifically, solutions are provided for managing configurations for discontinuous reception in the wireless device.

### BACKGROUND

Various protocols and technical requirements for wireless communication have been standardized under supervision of inter alia the 3rd Generation Partnership Project (3GPP). Improvement and further development are continuously carried out, and new or amended functions and features are thus implemented in successive releases of the technical specifications providing the framework for wireless communication.

Wireless communication may in various scenarios be carried out between a wireless network and a wireless device. The wireless network typically comprises an access network including a plurality of access nodes, which historically have been referred to as base stations. In a 5G radio access network such a base station may be referred to as a gNB. Each access node may be configured to serve one or more cells of a cellular wireless network. A variety of different types of wireless devices may be configured to communicate with the access network, and such wireless devices are generally referred to as User Equipment (UE). Communication which involves transmission from the UE and reception in the wireless network is generally referred to as Uplink (UL) communication, whereas communication which involves transmission from the wireless network and reception in the UE is generally referred to as Downlink (DL) communication.

Every UE needs to be powered in some way to be able to communicate with the wireless network. Regardless of the capability of the UE, energy conservation is a relevant factor to consider. In various types of 3GPP radio access technologies, procedures for connected mode discontinuous reception (DRX) have been implemented, which inter alia has the benefit of reducing energy consumption in the UE. DRX may be configured for idle mode or connected mode operation.

In plain terms, when the UE is configured with connected mode DRX, or C-DRX, the UE follows a configured DRX cycle comprising a period of inactivity at which the UE powers down most of its circuitry. This period may be referred to as an Off Duration. With a periodicity defined by the DRX cycle, the UE powers up and holds its radio receiver active for a duration referred to as an On Duration. If an indication is received that data is transmitted in the DL in the On Duration period, a configured DRX inactivity timer may prolong the time the radio receiver is active, thus reducing the actual off period of the subsequent Off duration.

DRX configuration has thus been implemented for data traffic with expected longer periods of inactivity. A further legacy development is the use of so-called short DRX cycles, as opposed to a general long DRX cycle, and implies that the UE is configured with shorter intervals of inactivity between the On Durations. This may be triggered by UE reception of DL data in an On Duration of a long DRX cycle. The UE then applies a shorter DRX cycle, known as Short DRX Cycle duration, for a certain pendency, which may be determined by a timer. The UE is thus able to receive data more frequently for that pendency. The duration of the long DRX Cycle duration is in this context an integer multiple of the short DRX Cycle duration.

Legacy DRX configuration has thus improved the possibility for UE to conserve energy, while at the same time allowed for the network to conveniently use its radio resources for other purposes, when e.g. scarce DL traffic is transmitted. However, current DRX configurations are inflexible, and are not suited for many evolving application types.

### SUMMARY

In view of the foregoing, it is an objective to present a solution for managing DRX configuration for UEs connected to a wireless network, which serve to reduce energy consumption in the UE. An aspect of this objective is to provide a more flexible solution for configuring UEs according to an intended DRX configuration.

The proposed solution, which targets these objectives, is set out in the independent claims, whereas various examples thereof are set out in the dependent claims and in the following detailed description.

According to a first aspect, a method carried out in an access node of a wireless network is provided, for managing configuration of DRX for a UE, wherein the method comprises:
transmitting, to the UE, radio configuration information for a plurality of different DRX configurations;
obtaining traffic information indicative of data traffic intended for the UE;
transmitting, to the UE, an indication of a determined DRX configuration, identifying at least one of said plurality of different DRX configurations based on the traffic information;
conveying the data traffic to the UE based on the determined DRX configuration.

An access node of a wireless network is further provided, comprising:
a transceiver for wireless communication with a UE; and
logic circuitry configured to control the access node to carry out the method of the proposed solution, such according to the first aspect, for managing DRX configuration for the UE.

According to a second aspect, a method carried out in a UE is provided for managing DRX configuration, wherein the method comprises:
receiving, from an access node of a wireless network, radio configuration information for a plurality of different DRX configurations;
receiving, from the access node, an indication of a determined DRX configuration, identifying at least one of said plurality of different DRX configurations based on traffic information indicative of data traffic intended for the UE;
receiving the data traffic using the determined DRX configuration.

A UE is further provided, comprising:
a transceiver for wireless communication with a wireless network; and
logic circuitry configured to control the UE to carry out the method of the proposed solution, such as according to the second aspect, for managing DRX configuration.

The proposed solutions provides support for multiple DRX configurations for the UE in order to reduce UE energy consumption, especially when the UE is expected to receive quasi-periodic traffic pattern(s). In this context, different DRX configurations may be applied for different applications, or more generally to different concurrent streams dependent on the relative traffic occasions for those streams. This provides, for example, the possibility of configuring and activating specific DRX configurations based on deterministic behavior of various applications.

### BRIEF DESCRIPTION THE DRAWINGS

FIG. 1 schematically illustrates an implementation of a wireless communication system, in which a UE communicates with a wireless network by radio communication.

FIG. 2 schematically illustrates a UE configured to operate with the wireless network according to various examples.

FIG. 3 schematically illustrates a network node configured to operate in the wireless network for communication with the UE according to various examples.

FIG. 4A generally illustrates DRX operation where different flows are received.

FIG. 4B illustrates a DRX configuration adapted to deterministic behavior of the data flows, according to one example.

FIG. 5A illustrates a DRX configuration with multiple DRX cycles, according to one example.

FIG. 5B illustrates a DRX configuration with On durations adapted to deterministic behavior of the data flows, according to one example.

FIG. 6 illustrates a signaling diagram, identifying various aspects of the proposed solution.

FIG. 7 is a flowchart illustrating various steps carried out by the access node according to an embodiment of the proposed solution.

FIG. 8 is a flowchart illustrating various steps carried out by the UE according to an embodiment of the proposed solution.

### DETAILED DESCRIPTION

In the following description, for the purposes of explanation and not limitation, details are set forth herein related to various examples. However, it will be apparent to those skilled in the art that the present invention may be practiced in other examples that depart from these specific details. In some instances, detailed descriptions of well-known devices, circuits, and methods are omitted so as not to obscure the description of the present invention with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

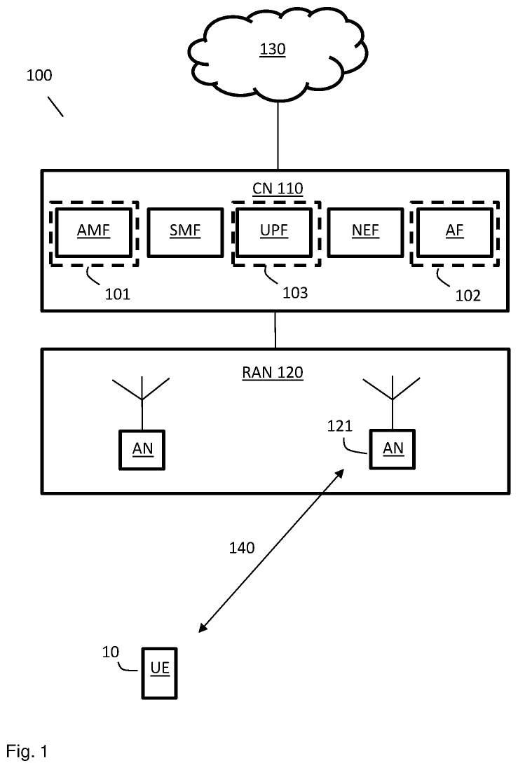

FIG. 1 illustrates a high-level perspective of operation of a UE 10 in a wireless system, configured to communicate with a wireless communication network 100, denoted wireless network 100 for short herein. The wireless network 100 may be a radio communication network 100, configured to operate under the provisions of 5G as specified by 3GPP, according to various examples, or further generations. The wireless network 100 may comprise a core network (CN) 110, connectable to an external network 130 such as the Internet. The core network may comprise a plurality of core network nodes, which realize logical functions. For the example of a 5G system, as illustrated, this may inter alia include the Access and Mobility Management Function (AMF), a Session Management Function (SMF), a User Plane Function (UPF), a Network Exposure Function (NEF), and an Application Function (AF), all of which are legacy functions of the 5G system. The AF(s) may also be deployed outside of the 5G system i.e. as an application running on an application server connected to the external network e.g. the Internet.

The core network 110 is connected to at least one access network 120 comprising one or more base stations or access nodes, of which one access nodes 121 is illustrated. The access node 121 is a radio node configured for wireless communication on a physical channel 140 with various UEs, such as the relay device 20. The physical channel 140 may be used for setting up one or more logical channels between UEs and the wireless network, such as with the AMF.

Before discussing further details and aspects of the proposed method, functional elements for examples of the entities involved in carrying out the proposed solution will be briefly discussed, including the access node 121 and the UE 10.

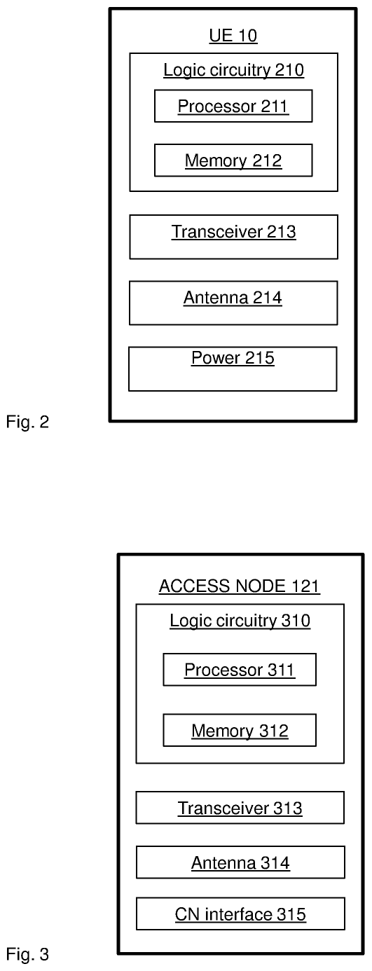

FIG. 2 schematically illustrates an example of the UE 10 for use in a wireless network 100 as presented herein, and for carrying out various method steps as outlined. Some relevant elements or functions of the UE 10 are shown in the drawing. The UE 10 may however include other features and elements than those shown in the drawing or described herein, such as a casing, a user interface, sensors, etc., but these are left out for the sake of simplicity.

The UE 10 comprises a radio transceiver 213 for communicating with other entities of the radio communication network 100, such as the access node 121, in one or more frequency bands. The transceiver 213 may thus include a receiver chain (Rx) and a transmitter chain (Tx), for communicating through at least an air interface.

The UE 10 may further comprise an antenna system 214, which may include one or more antennas, antenna ports or antenna arrays. In various examples the UE 10 is configured to operate with a single beam, wherein the antenna system 214 is configured to provide an isotropic gain to transmit radio signals. In other examples, the antenna system 214 may comprise a plurality of antennas for operation of different beams in transmission and/or reception. The antenna system 214 may comprise different antenna ports, to which the Rx and the Tx, respectively, may selectively be connected. For this purpose, the antenna system 214 may comprise an antenna switch.

The UE 10 further comprises logic circuitry 210 configured to communicate data and control signals, via the radio transceiver, on a physical channel 140 to a serving access node 121 of the wireless network 100. The logic circuitry 210 may include a processing device 211, including one or multiple processors, microprocessors, data processors, co-processors, and/or some other type of component that interprets and/or executes instructions and/or data. The processing device 211 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic circuitry 210 may further include memory storage 212, which may include one or multiple memories and/or one or multiple other types of storage mediums. For example, the memory storage 212 may include a random access memory (RAM), a dynamic random access memory (DRAM), a cache, a read only memory (ROM), a programmable read only memory (PROM), flash memory, and/or some other type of memory. The memory storage 212 may include a hard disk (e.g., a magnetic disk, an optical disk, a magneto-optic disk, a solid state disk, etc.). The memory storage 212 is configured for holding computer program code, which may be executed by the processing device 211, wherein the logic circuitry 210 is configured to control the UE 10 to carry out any of the method steps as provided herein. Software defined by said computer program code may include an application or a program that provides a function and/or a process. The software may include device firmware, an operating system (OS), or a variety of applications that may execute in the logic circuitry 210.

The UE 10 further comprises a power supply 215 that provides energy to the other components of the UE 10.

FIG. 3 schematically illustrates a radio node in the form of an access node 121 of the wireless network 100 as presented herein, and for carrying out the method steps as outlined. An access node 121 may have one or more transmission and reception point(s) TRP(s). In various examples, the access node 121 is a radio base station for operation in the radio communication network 100, to serve one or more radio UEs, such as the UE 10.

The access node 121 may comprise a wireless transceiver 313, such as a radio transceiver for communicating with other entities of the radio communication network 100, such as the terminal 10. The transceiver 313 may thus include a radio receiver and transmitter for communicating through at least an air interface.

The access node 121 further comprises logic circuitry 310 configured to control the access node 121 to communicate with the UE 10 via the radio transceiver 313 on the physical channel 140.

The logic circuitry 310 may include a processing device 311, including one or multiple processors, microprocessors, data processors, co-processors, and/or some other type of component that interprets and/or executes instructions and/or data. Processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic circuitry 310 may further include memory storage 312, which may include one or multiple memories and/or one or multiple other types of storage mediums. For example, memory storage 312 may include a random access memory (RAM), a dynamic random access memory (DRAM), a cache, a read only memory (ROM), a programmable read only memory (PROM), flash memory, and/or some other type of memory. Memory storage 312 may include a hard disk (e.g., a magnetic disk, an optical disk, a magneto-optic disk, a solid state disk, etc.).

The memory storage 312 is configured for holding computer program code, which may be executed by the processing device 311, wherein the logic 310 is configured to control the access node 121 to carry out any of the method steps as provided herein. Software defined by said computer program code may include an application or a program that provides a function and/or a process. The software may include device firmware, an operating system (OS), or a variety of applications that may execute in the logic 310.

The access node 121 may further comprise, or be connected to, an antenna 314, which may include an antenna array. The logic 310 may further be configured to control the radio transceiver to employ an isotropic sensitivity profile of the antenna array to transmit radio signals in a particular transmit direction. The access node 121 may further comprise an interface 315, configured for communication with the core network 110. Obviously, the access node 121 may include other features and elements than those shown in the drawing or described herein, such as a power supply and a casing etc.

Throughout the years, the use of UEs in wireless networks has developed considerably. From originally being designed for voice communication, the wireless networks, and the technical specifications associated to operation and configuration of such networks, are predominantly used for data communication. Moreover, different use cases and applications continuously develop, and different UE types are implemented, particularly UE type for a specific use-case, such as non-user handled devices commonly referred to as Internet of Things (IoT) devices of comparatively low-complexity. Different so-called verticals have been defined, to identified different types of context and use cases.

Supporting Extended Reality (XR) is one of those verticals. The term Extended Reality (XR) is used to identify real-and-virtual combined environments and human-machine interactions, and covers different types of several applications, such as Virtual Reality (VR), Augmented Reality (AR), and Cloud Gaming (CG). The main characteristics are requirements on relatively high data rate and low latency. 5G NR (New Radio) was introduced to support eMBB (high data rate), URLLC (low latency), and mMTC (high number of devices). Hence, 5G NR was not designed to support the combination of the aforementioned requirements which is suitable for XR applications.

Specifically, DRX operation is for various reasons not suitably designed for XR applications. In the other words, XR may not be optimally operated in 5G NR network, such as unable reaching the required data rate/latency and it also has high UE power consumption, hence, reducing user experience.

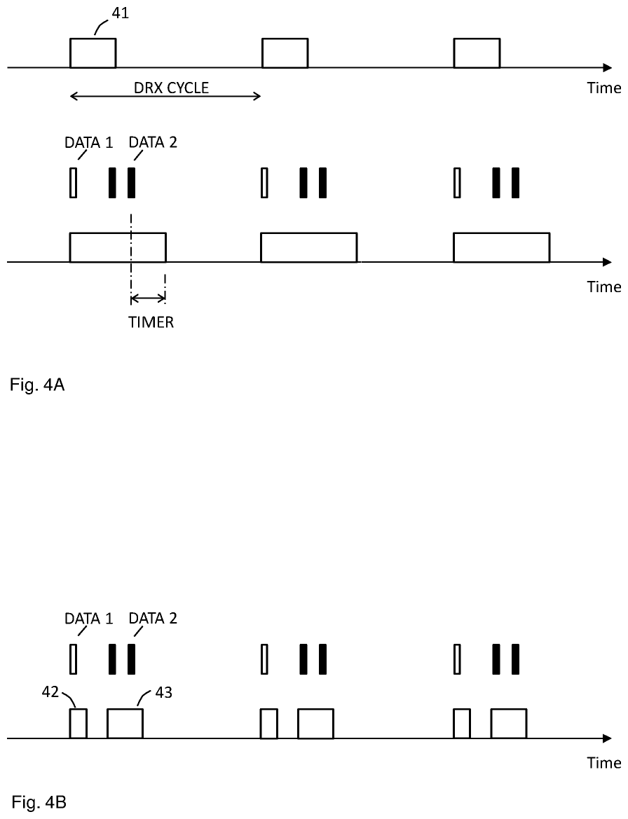

FIG. 4A is provided to schematically illustrate a problem associated with data communication for certain applications, such as certain XR applications. In the upper part of the drawing, a DRX configuration is illustrated, with On durations 41 repeated with a DRX cycle over time. In the lower diagram, data transmitted in DL is schematically shown. Specifically, in the example, different DL data, Data 1 and Data 2, is transmitted at different occasions in time. In some examples, these may refer to different data streams or data flows associated with a common XR application. If there is no data after the inactivity timer expires, an Off duration complementary to the On duration 41 starts. However, if the data keeps coming, as illustrated in the lower diagram of FIG. 4A, the On duration keeps extending with increasing energy consumption as a result. Current DRX parameters and configuration are thus not optimized for these types of transmission, such as certain XR applications.

According to a general aspect, and at least in part for overcoming this problem, a solution is proposed herein which comprises a method carried out in an access node of a wireless network, for managing configuration of DRX for a UE. The method comprises:
transmitting, to the UE, radio configuration information for a plurality of different DRX configurations;
obtaining traffic information indicative of data traffic intended for the UE;
transmitting, to the UE, an indication of a determined DRX configuration, identifying at least one of said plurality of different DRX configurations based on the traffic information;
conveying the data traffic to the UE based on the determined DRX configuration.

From an aspect of the UE, the method comprises the steps of:
receiving, from an access node of a wireless network, radio configuration information for a plurality of different DRX configurations;
receiving, from the access node, an indication of a determined DRX configuration, identifying at least one of said plurality of different DRX configurations based on traffic information related to data traffic intended for the UE;
receiving the data traffic using the determined DRX configuration.

The proposed solutions provides support for multiple DRX configurations for the UE in order to reduce UE energy consumption. In this context, different DRX configurations may be applied for different applications, or more generally to different concurrent streams dependent on the relative traffic occasions for those streams. This provides, for example, the possibility of configuring and activating specific DRX configurations which are XR traffic aware.

FIG. 4B discloses an example of an embodiment of how the proposed solution may be implemented. For certain applications, the traffic may be deterministic, such that traffic occasions, and potentially durations, for different streams are defined and known beforehand, in particular for DL traffic. For such traffic situations, e.g. for receiving XR application traffic, the UE does not need to necessarily activate the receiver all the time or activate it for a longer period according to legacy procedures during connected mode. The UE can adaptively switch off the receiver for a certain period when the UE does not expect to receive the downlink data. As is illustrated in FIG. 4B, this may be accomplished by activating the determined DRX configuration, which is selected to suite the deterministic behavior of the data traffic intended for the UE. In the shown example, the determined DRX configuration comprises two On durations 42 and 43, with an intermediate off period, wherein those two On durations are cyclically repeated. While this is one example, it shall be understood that where the data traffic is deterministic, unnecessary width and extension of the On duration can be avoided.

In some examples, the plurality of DRX configurations may comprise a legacy type DRX configuration, such as long DRX, short DRX or extended DRX (eDRX). Moreover, the plurality of DRX configurations comprises at least one DRX configuration which may be tailored to data traffic type or character, e.g. based on number of flows, frame rate, or application type.

In various examples of the proposed solution, the traffic information identifies the determined DRX configuration, which is a selected DRX configuration out of the plurality of DRX configurations. In some embodiments, the access node 121 may receive traffic information that contains or points to a certain determined DRX configuration, which may have been identified in the core network 110. In other embodiments, the access node 121 receives the traffic information and makes the determination to establish the determined DRX configuration. The traffic information may comprise data flow information of said data traffic, such as data associated with active data flows. The data flow information may identify at least frame rate of one or more data flows of the data traffic. The data flow information may further identify number of data flows, and optionally data rate of the one or more data flows of the data traffic. Selecting the determined DRX configuration may involve determining, by the access node 121, one of said plurality of different DRX configurations based on the data flow information.

In some examples, the traffic information comprises application information of said data traffic. In this context, the application information may identify an application type, such as VR, AR, etc., or a group ID associated with a sort of application, or may uniquely identify an application. The access node 121 may further be configured to determine one of said plurality of different DRX configurations, i.e. select the determined DRX configuration, based on the application information. The application information may, explicitly or implicitly, identify frame rate of one or more data flows. The application information may further identify number of data flows, and optionally data rate one or more data flows of the data traffic. In one embodiment, the application information may identify the UE 10, or a UE context in the application, associated with the UE 10, which is cashed in a network node of the wireless network 100, in or accessible to the access node 121. The cashed information may tie a certain DRX configuration to be used for the UE, or for data traffic associated with a certain application for that UE. The access node 121 may in such a case be arranged to select the determined DRX configuration based on the cashed information.

In the context of the example of the traffic information comprising application information, a mapping of an application and an associated required number of streams may be defined, which mapping is usable in the access node 121, or another node of the wireless network 100, to identify data flow information related the application information. For the example of XR, this mapping may comprise an identification of expected number of data flows/streams for each XR application, such as VR, AR, CG.

An example of this is shown in Table 1 below which provides mapping between application, or application type, and flows with one or more flow parameters. Each application type is identified by an application ID which may identify a type or group of applications. The determined DRX configuration may be based on the mapping, wherein the traffic information may contain the ID.

TABLE 1

| | | | Parameter 1 | Parameter 2 |
|---|---|---|---|---|
| | | | (Frame rate/ | (Data rate- |
| ID | Application | Flows | Periodicity) | Mbps) |
| 1-1 | VR | 1 | 30 fps | 20 |
| 1-2 | | 2 (I-frame & | 60 fps | 10 & 20 |
| | | P-frame) | | |
| 1-3 | | 2 (Video & | 30 fps, 10 ms | 20 & 2 |
| | | Audio/Data) | | |
| 2-1 | CG | 1 | 120 fps | 30 |
| 2-2 | | 2 (I & P) | 60 fps, 10 ms | 8 & 14 |
| 3-1 | AR | 1 | 60 fps | 10 |
| 3-2 | | 2 (Video & | 30 fps, 10 ms | 30 & 2 |
| | | Audio/Data) | | |

In some examples, the parameter 1 may be used as input to select the determined DRX configuration, such that On durations have a matching cyclic behavior with regard to the frame rate. Optionally, parameter 2 may be used as input to select the determined DRX configuration, such that sufficiently long On durations are obtained.

The selection of the determined DRX configuration may be dependent on the traffic information of incoming data for the UE, and may further be based on traffic condition and packet arrival time. The possible DRX configuration for each stream and possible combination of DRX configurations for multiple streams can be predefined, based on characteristics of the traffic information. In some embodiments, a core network node, such as the UPF 103 or other support function, analyses incoming data traffic from the AF to identify its character, such as number of flows and associated frame rates. The core network node may thereby define the traffic information, based on the identified character. In some embodiments, the traffic information, identifying flows and associated parameters, is obtained in the core network 110 from application layer to radio layer.

According to some embodiments, the capability of the UE 10, and possibly also of the access node 121, is established in an initialization phase. The access node 121 may indicate its supporting of multiple DRX configuration operation with or without the supported detailed parameters to a core network node. Unless the access node 121 has this capability, the core network 110 need not supply traffic information for the access node 121 to use to identify a suitable DRX configuration. The UE 10 may further be arranged to indicate its capability to support and operate different DRX configurations. The capability information can be informed to the access node 121 and/or the AMF 101. This capability information may identify supported services, support for certain types of flows with certain parameter characteristics, or certain types of application types or groups. Affirmed capability of the UE 10 to handle different DRX configurations is in some embodiments be required for the access node 121 to carry out the step of transmitting radio configuration information for a plurality of different DRX configurations.

In some embodiments, selection of a determined DRX configuration based on traffic information may be activated/triggered with different possible methods.

According to one example, the selection of a determined DRX configuration may be initiated by a core network initiated request of a certain application, e.g. an XR application, to a serving access node 121 and/or the UE 10. The AMF 101 may identify the associated traffic information, e.g. related to flows and associated frame rate, and inform the access node 121. Alternatively, the AMF 101 provides this traffic information to the UE in a NAS message, wherein the UE 10 informs the serving access node 121. As noted, the traffic information may comprise an indication of application type or group, such as an application ID (e.g. identifying AR, CG, VR, and with one or multiple streams). Alternatively, the traffic information may convey number of flows and its parameter characteristics. Hence, the radio resource management of the wireless network 100 is aware the existence of multiple flows so that a specific DRX configuration can be applied. In this context, application types and flows have been discussed in 3GPP technical report TR 26.926 version 1.0.0 (2022). In various embodiments, this information is used as input or enabler for the operation of multiple DRX configuration.

In some embodiments, the traffic information may identify a starting time for activation of the determined DRX configuration, and/or an ending time.

The traffic information is used for mapping the data traffic to an associated determined DRX configuration. If the traffic information is provided to the access node 121, the access node 121 applies it directly and informs the UE 10. Alternatively, the traffic information may come directly to the UE 10, and the UE 10 will provide UE assistance information (UAT) to the access node 121. The assistance information may comprise the preferred multiple DRX configuration based on the received traffic information.

According to another example, the selection of a determined DRX configuration may be initiated by a UE-initiated request of a specific application to the serving access node 121. This may indicate the application type and possibly also preferred or selected DRX configuration(s). The request may also indicate an associated duration of use of the determined DRX configuration. The duration may indicate how long the UE 10 will need to apply this DRX configuration, such as a certain multiple DRX configuration. The information could be at least the starting time and the expected “running time”. As an example, related to a teleconference meeting, the UE 10 may have obtained the expected meeting time duration. As an alternative, the configuration may be valid at least for X minutes. The UE 10 may further inform the access node 121 that it may need to prolong for another X minutes, e.g. before the end of the first X minutes.

In various examples, the UE 10 is configured to report sensed channel quality, such as signal to noise ratio (SNR). At high SNR the UE 10 may support high modulation/coding scheme, resulting in a higher data rate. Hence, a packet can be transferred quickly so that a DRX configuration with shorter On duration may be applied. The method may thus comprise receiving channel quality information in the access node 121 from the UE 10, wherein the determined DRX configuration is determined dependent on the channel quality information.

Radio configuration for the DRX configurations are in some embodiments conveyed to the UE 10 using a radio resource control (RRC) message. On supporting multiple DRX, the configuration size is expected to be larger, for which RRC messaging is appropriate. However, RRC messages are typically quite slow. The UE is typically adapting the received new configuration after a few-hundred milliseconds. Furthermore, it may not be efficient to transfer the bulky RRC configuration each time the UE require a new configuration. For this reason it is proposed that while the radio configuration information for the plurality of different DRX configurations is transmitted in an RRC message, the indication of the determined DRX configuration is carried out by a lower layer control command. This ensures rapid adjustment of the DRX configuration to use oi the UE 10.

The radio configuration, comprising details of one or more DRX configurations, such as a set of configuration parameters, are thus conveyed in RRC message. In some examples, these details are grouped based on traffic information or on application. In various embodiments, the radio configuration may comprise details for multiple radio configurations, comprising DRX configurations usable for conveying associated different flows of a certain application concurrently. As described above, this may e.g. be used for different associated data flows with different frame rate/periodicity. The UE 10 may thus be configured with one or more DRX configurations.

As indicated with reference to FIG. 4B, in some embodiments a configuration may be determined which comprises separate On durations 42, 43 for different flows related to data 1 and data 2. Further, as exemplified with reference to certain XR applications, such different flows may even have different individual frame rate. For such examples, it may be considered that the UE 10 is set to operate multiple DRX configurations at the same time. Alternatively, this may be defined as a DRX configuration which is characterized by two DRX cycles for different On durations. Either way, this is here referred to as a multiple DRX configuration.

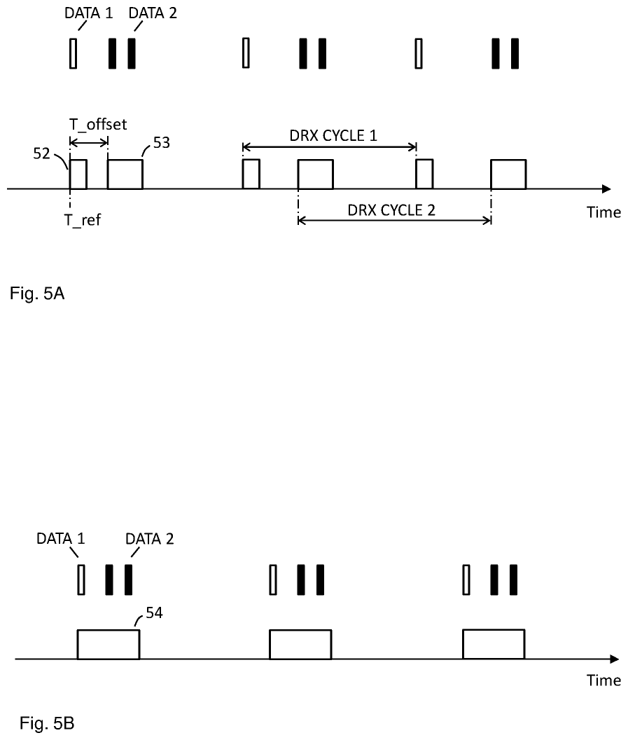

On the arrangement of a multiple DRX configuration, an offset between different DRX cycles may also be defined in various embodiments, such when two data flows are correlated in time. The offset may e.g. identify a time shift between starting points for an instance of the first On duration and an instance of the second On duration, to accommodate for said correlation. This information may be signaled explicitly to the UE 10 by the access node 121, or may be determined implicitly by the UE 10 based on an identification of starting times for an occasion of the first On duration and an occasion of the second On duration. Said starting times may be defined with respect to two different flows where each of the flows starts with a packet at a specific time. The explicit or implicit identification of the time shift may be conveyed in RRC with the radio configuration. Alternatively, the identification of the offset is conveyed with the indication identifying multiple DRX configuration as the determined DRX configuration, where it may be based on the traffic information. This is schematically illustrated in FIG. 5A. In this example, the multiple DRX configuration defines first On durations 52 with a first DRX cycle (DRX CYCLE 1), adapted to a first flow of Data 1. Moreover, second On durations 53 are defined with a second DRX cycle (DRX CYCLE 2), adapted to a second flow of Data 2. In this example, the first and second DRX cycles are different, i.e. the multiple DRX configuration identifies two different periodicities. The offset T_offset is defined relative to a reference time point T_ref. In some examples, T_ref identifies the system frame number (SFN) number, e.g. pointing to the first sub-frame/slot and first OFDM symbol of that SFN. In another example, T-ref identifies a start of an instance (e.g. the first) of the first On duration 52. The offset may be provided relative to T_ref with the granularity slot and/or OFDM symbol number. It may be noted that for an example as provided in FIG. 5A, where the DRX cycles 1 and 2 are different, the actual offset is not static but will change for every cycle. However, based on both DRX cycles and one indication of T_offset being defined, the evolving true offset will follow automatically.

In some examples, the actual offset between On durations of two flows may be relatively short. In such a scenario, the access node 121 can decide to combine them and make a single DRX configuration and convey to the UE 10. This can be transparent to the UE 10. Alternatively, the access node 121 can send a multiple DRX configuration to the UE 10, whereas the UE 10 may be arranged to selectively implement a DRX configuration where the multiple DRX configurations are combined in a longer On duration 54. Both these examples may provide the DRX configuration as shown in FIG. 5B in the UE 10. Based on the deterministic behavior of the data flows, this nevertheless provides basis for shorter On durations than in legacy DRX since the On duration 54 will be defined with respect to an expected data rate and frame rate, such that the inactivity timer is less likely to extend the On duration 54.

Once the application is triggered, the indication of the determined DRX configuration, such as a multiple DRX configuration, is conveyed to the UE 10. As the full DRX configurations have already been transmitted, the indication may simply make reference to one of those, such as a DRX ID of one of the plurality of DRX configurations.

Transmitting the indication of the determined DRX configuration is in some embodiments carried out by a lower layer control command, such as a layer 1 (L1) and/or layer 2 (L2) command. This has the technical effect of being faster than higher layer reconfiguration by RRC, and is made suitable due to the indication not having to contain a lot of data. In some examples, the indication may be a single bit, two bits, or more. In some examples, the indication of the determined DRX configuration is transmitted in a medium access control, MAC, control element, CE. This is known as L2 command. In another example, the indication of the determined DRX configuration is transmitted in downlink control information, DCL This is known as L1 command.

During the operation of providing data traffic, it can be identified that one or more flows/streams are no longer used, either temporarily or permanently for that application session. In some examples, a suspend/resume process of the DRX configuration is therefore implemented. In this context, one or more specific DRX configurations of a multiple DRX configuration can be suspended or be added to save energy, by transmitting an update indication to the UE 10. In some examples, the access node 121 may transmit an over-ride indication to the UE 10, which provides an always ON indication, optionally with an DRX ON timer, in case there is additional unpredictable traffic. Such indications may be transmitted by the access node 121 via lower layer signaling, e.g. MAC or control channel, with or without timer.

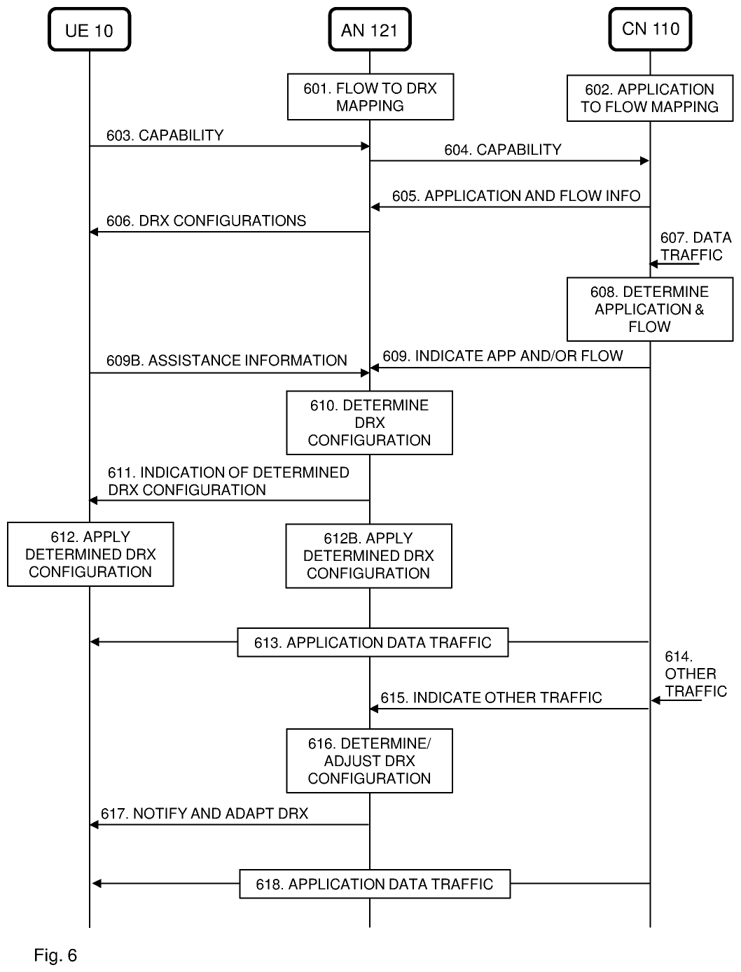

FIG. 6 schematically illustrates a signaling diagram of an example of an AMF-initiated request of a specific application case, which is usable for understanding also other alternatives of the proposed solution as outlined herein. It may be noted that FIG. 6 does not explicitly contain all required communication, such as the setting up of a connected mode channel, HARQ procedures for acknowledging reception, or security models. Legacy procedure may apply. Moreover, it shall be understood that when reference is made to an access node 121 herein, various steps of the proposed solution many take place with an intermediate handover process from a first access node to a second access node. These are herein both referred to as “the” access node for the purposes of understanding the proposed solutions.

In optional steps 601 and 602, the core network 110 and the access node 121 are configured to one or more supported predefined applications. Here, the core network 110 may be configured for flow mapping based on the application. In various embodiments, the UPF handles the data and the flow mapping and the SMF handles the data session, whereas the AMF manages signaling and configurations The access node 121 may be configured for mapping DRX configurations based on the flows. Examples related to these steps were outlined in reference to Table. 1 above.

In some examples, a transfer of capability and/or support for different services, applications, flow types and combinations, etc., may be carried out in steps 603 and 604. This capability exchange can be done prior to any connection setup at initial attach procedure of the UE 10. The UE 10 may thereafter be in Idle mode.

In step 605 the AMF 101 signals the access node 121 on the supported application(s) and the associated flow(s) mapping configuration, and/or quality of service (QoS) aspects for the different flows. As an alternative, as outlined above, the signaling of step 605 may include or identify DRX configurations or traffic information related to associated flows of the respective application. In such an embodiment, the access node 121 need not be application aware.

In step 606 the access node 121 provides the plurality of DRX configurations to the UE 10 that may be used at a later stage. This may include the configuration of different application related RAN parameters, e.g., all possible supported parameters for multiple DRX operation. In some embodiments, this can be considered as one-time signaling so that the UE 10 has acquired this information before the UE 10 starts the application, such as an XR application.

An application setup phase, which may include the AMF 101 paging the UE 10 and initiating connection setup, may typically be involved. This may be carried out after steps 605 and 606. In an alternative scenario, steps 605 and 606 are carried out after, such as responsive to, initiation of the application setup when data traffic 607 is pending. In such an embodiment, DRX configuration step 606 may form part of a process to finalize the application setup process.

In step 607 a network node of the core network 110, such as the UPF 103, receives data traffic for the application, such as XR traffic, from the cloud or an application server in the wireless network 100. The data traffic may be received with an indication on the type of traffic (e.g., XR type).

In step 608 the application and the associated number of flows and its parameters are determined in the core network 110. This may be carried out by the UPF 103, or by the AMF 101 based on information from the UPF 103.

In step 609, the core network 110, e.g. the AMF 101, signals traffic information associated with the data traffic to the access node 121, which may identify the determined application and/or flow(s). This can explicitly provide the number of flows and the associated parameters. Alternatively, e.g. if the access node 121 is configured to be application aware, this can be represented by an index value identifying the application. The access node 121 is preconfigured to know the number of flows and the associated parameters of that flow.

As outlined earlier, initiation of an application session may be carried out in the UE 10, wherein the UE obtains information of the data traffic. The UE 10 may be informed directly from the application layer or from the cloud (outside CN) that a specific application with an associated traffic pattern will be performed by the UE 10. The information of the data traffic may comprise an identification of an application, and/or data related to flows of the traffic data, and/or a preferred DRX configuration to apply for receiving the data traffic. Alternatively, the UE may also derive/identify the preferred DRX configuration from the received information of the data traffic. After obtaining this information, the UE 10 will provide 609B traffic information as UE assistance information to the access node 121, which may comprise or be based on the obtained information. The traffic information may thus identify an identification of an application, and/or data related to flows of the traffic data, and/or a preferred DRX configuration to apply for receiving the data traffic.

In step 610, the access node 121 identifies the determined DRX configuration to apply. As noted, this may be determined by the access node 121 based on the received traffic information, and/or the assistance information from the UE 10.

In step 611, an indication of the determined DRX configuration is signaled to the UE 10. To minimize latency, the access node 121 can provide this indication in lower layer, e.g. DL MAC CE or DL DCI. The access node 121 only needs to provide a DRX config ID referring to details that were previously conveyed in step 606. In an alternative embodiment, an application setup process for the UE 10 comprises the step of configuring 611 the UE to use a determined DRX configuration, wherein the indication of the determined DRX configuration may be carried out in RRC configuration.

In step 612, the UE 10 applies the determined DRX configuration based on the received indication, and the access node applies the corresponding DRX configuration in DL transmission in step 612B.

In step 613, application data traffic, such as XR traffic, is commenced and the UE 10 adapts its operation using the DRX configurations to moderate energy consumption. This includes the access node 121 conveying data traffic to the UE 10.

Step 614 indicates the case that there is incoming other traffic. In some scenarios the other traffic may represent a change of the traffic information or characteristics of the data traffic, wherein e.g. one flow of an application is either added or cancelled. In some scenarios, the other traffic is received in addition to the application traffic data, e.g. Non XR traffic such as voice call, ftp, etc. In this scenario, the core network 110 indicates 615 traffic information associated with the other traffic to the access node 121. In step 616, the access node 121 may determine to change or adapt the currently applied DRX configuration, based on the traffic information related to the other traffic.

The access node 121 notifies the UE 10 in step 617, and there are in this case at least the following three possible options for adapting the DRX configuration used:
Indicate Always ON, i.e. drop present DRX configuration, for certain period. This may e.g. be applied responsive to the other traffic being URLLC-type data, in which case the UE 10 has to receive it quickly and with high reliability.
Indicate to suspend 1-2 DRX configuration for certain period, where some of the DRX configurations of multiple DRX configuration may not be needed. In this case, the access node 121 indicates to the UE 10 that one or more of the configured Multiple DRXs is no longer used either temporarily or permanently until further indication from the access node 121.
Indicate to change to another DRX configuration, if the new other traffic is yet another deterministic transmission, such as a voice call, or an additional flow of the current application.

In the foregoing, various details of the proposed solution have been outlined, with reference to different examples. While it is noted that the proposed solution is appropriate for the deterministic behavior of XR applications, the solutions are not bound to such scenarios. There are also other applications with multiple data streams requiring different characteristics that may benefit from the proposed solution, like factory automation, remote machine operation, UAV operation, or just to differentiate between video and audio.

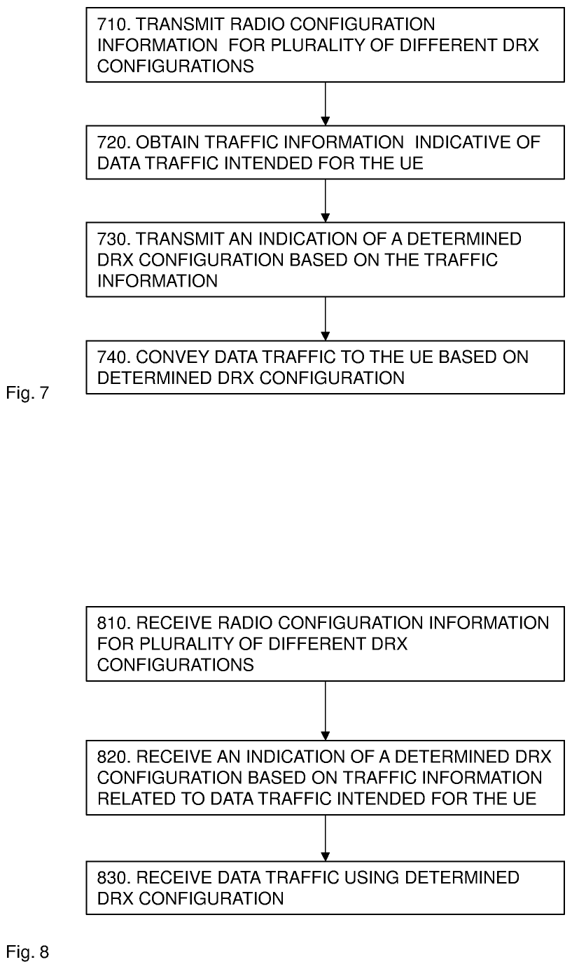

FIGS. 7 and 8 are flowcharts identifying various steps associated with the proposed solution as carried out in the access node 121 and in the UE 10, respectively. These flowcharts encompass the more detailed examples of embodiments laid out in the foregoing.

FIG. 7 shows a flowchart of a method carried out in the access node 121 of a wireless network 100, for managing configuration of DRX for the UE 10. The method comprises the following steps.

In step 710 the access node 121 transmits radio configuration information to the UE 10 for a plurality of different DRX configurations. In this context, the radio configuration information may comprise radio parameter data, such as required RAN parameters, for setting up and applying communication according to the associated DRX configuration. The radio configuration information may thus identify at least one DRX cycle and at least an associated starting point for a DRX On duration identifying e.g. symbol, slot, SFN or the like. The radio configuration information may further identify an inactivity timer information for the On duration. The radio configuration may be detailed and explicit, or may be provided by a code or flag that can be analyzed in the UE 10 to identify the intended radio DRX configuration. The radio configuration information may be transmitted using RRC signaling. The purpose of the radio configuration information is thus allowing the UE to understand a DRX pattern that is or may later be applied, wherein the access node 121 may transmit data during such On durations and expect the UE 10 to listen for data (and potentially initiate UL transmission) during such On durations.

In step 720 the access node 121 obtains traffic information indicative of data traffic intended for the UE 10. The traffic information may be information defining properties of active data flows of the data traffic intended for the UE 10. The traffic information may in some embodiments explicitly provide or point to a certain determined DRX configuration, usable or suitable for transmitting the data traffic. This may be based on the type and number of flows associated with the data traffic, where such flows may have different periodicities, and or based on an application, such as an application type. In other embodiments, the traffic information comprises information on the type and number of flows associated with the data traffic, where such flows may have different periodicities, and/or information on the application, such as on the application type. In such an embodiment, the access node 121 may be configured to determine said determined DRX configuration, usable or suitable for transmitting the data traffic, based on the obtained traffic information. The traffic information may e.g. be received 609 from the core network 110 or received 609B from the UE 10.

In step 730 the access node 121 transmits an indication of the determined DRX configuration to the UE 10, identifying at least one of said plurality of different DRX configurations based on the traffic information. By this step, the access node 121 makes the UE 10 aware of the DRX configuration to use, based on the traffic information. Examples of this step are provided at 611 and 617 in the embodiment of FIG. 6. In some examples, this may be accomplished by lower level signaling, such as DCI or MAC CE.

In step 740 the access node conveys the data traffic to the UE based on the determined DRX configuration. This may involve using a connected mode DRX procedure according to the determined DRX configuration, wherein conveying includes transmitting the data traffic in DL from the access node 121 to the UE 10. In the wireless network 100, the access node 121 will receive DL data from the core network, which provide application data traffic from an application server, located in the network 100 or connected to the network 100. This is indicated in by 613 in the example provided in FIG. 6.

As discussed herein, one or mode DRX configurations may be applied as multiple DRX configurations which the UE 10 is configured to apply concurrently. This may involve at least two DRX cycles with associated On durations, which are suitable to use for at least DL data traffic associated with an application or use case where two different flows are included. Such flows may have different frame rate or periodicity, and the multiple DRX configurations may be designed or applied to accommodate On durations for both flows.

In this context, the flowchart of FIG. 7 may be used for an embodiment which is discussed in relation to the later process steps in the example of FIG. 6. In such a context, the method carried out in the access node 121 for managing configuration of DRX for the UE may comprise:

Transmitting 710, to the UE, radio configuration information for a plurality of different DRX configurations. This may involve transmitting an indication 611 to the UE, which identifies a DRX configuration to apply, which is used for conveying data traffic by transmitting data packets in at least DL from the access node 121 to the UE 10 in step 613.

Obtaining 720 traffic information indicative of data traffic intended for the UE. This may include receiving 615 an indication of other incoming traffic, or a change of the present data traffic.

Transmitting 730, to the UE, an indication of determined DRX configuration, identifying at least one of said plurality of different DRX configurations based on the traffic information. An example of this is provided in step 617 of FIG. 6. This may involve determining 616, by the access node 121, that another DRX configuration shall be used, or that an adjustment shall be made in the currently applied DRX configuration. Where the current DRC configuration is multiple DRX configurations, this may involve determining to adjust that current DRX configuration based on e.g. a flow being added or cancelled, or other alternatives as outlined above.

Conveying 740 the data traffic to the UE based on the determined DRX configuration. This may involve transmitting 618 data be means of the access node 121 to the UE using the determined or adjusted DRX configuration.

FIG. 8 provides a flow chart for steps carried out in the UE 10, for managing the DRX. The method comprises the following steps.

In step 810 the UE 10 receives radio configuration information from the access node 121 for a plurality of different DRX configurations. In this context, the radio configuration information may comprise radio parameter data, such as required RAN parameters, for setting up and applying communication according to the associated DRX configuration. The radio configuration information may thus identify at least one DRX cycle and at least an associated starting point for a DRX On duration identifying e.g. symbol, slot, SFN or the like. The radio configuration information may further identify an inactivity timer information for the On duration. The radio configuration may be detailed and explicit, or may be provided by a code or flag that can be analyzed in the UE 10 to identify the intended radio DRX configuration. The radio configuration information may be transmitted using RRC signaling. The purpose of the radio configuration information is thus allowing the UE to understand a DRX pattern that is or may later be applied, wherein the access node 121 may transmit data during such On durations and expect the UE 10 to listen for data (and potentially initiate UL transmission) during such On durations.

In step 820 the UE 10 receives an indication of a determined DRX configuration from the access node 121, identifying at least one of said plurality of different DRX configurations based on the traffic information. By this step, the UE 10 is made aware of the DRX configuration to use, based on the traffic information. Examples of this step are provided at 611 and 617 in the embodiment of FIG. 6. In some examples, this may be accomplished by lower level signaling, such as DCI or MAC CE.

The determined DRX configuration is based on traffic information related to data traffic intended for the UE. The traffic information may have been obtained in the wireless network as described herein, e.g. as described with reference to FIG. 7 above, and may cause the access node to make the determination of the determined DRX configuration. In some embodiments, the traffic information may be transmitted from the UE 10 to the access node 121. access node;

In step 830 the UE 10 receives the data traffic using the determined DRX configuration from the access node 121. This may involve using a connected mode DRX procedure according to the determined DRX configuration.

As discussed herein, one or more DRX configurations may be applied as multiple DRX configurations which the UE 10 is configured to apply concurrently. This may involve at least two DRX cycles with associated On durations, which are suitable to use for at least DL data traffic associated with an application or use case where two different flows are included. Such flows may have different frame rate or periodicity, and the multiple DRX configurations may be designed or applied to accommodate On durations for both flows.

In this context, the flowchart of FIG. 8 may be used for an embodiment which is discussed in relation to the later process steps in the example of FIG. 6. In such a context, the method carried out in the UE 10 for managing configuration of DRX for the UE may comprise:
receiving 810, from the access node 121, radio configuration information for a plurality of different DRX configurations. This may involve receiving an indication 611 from the access node 121, which identifies a DRX configuration to apply, which is used for receiving 613 data traffic in DL from the access node 121.
receiving 820, from the access node, an indication of a determined DRX configuration, identifying at least one of said plurality of different DRX configurations based on traffic information indicative of data traffic intended for the UE. In the example of FIG. 6, this may correspond to step 617. Here, the traffic information may indicate other incoming traffic or a change of the present data traffic, as represented by 614. The received indication 617 may identify a new or adjusted DRX configuration to apply, as received and determined by the access node 121, and may provide that another DRX configuration shall be used, or that an adjustment shall be made in the currently applied DRX configuration. Where the current DRC configuration is multiple DRX configurations, this may involve an adjustment of that current DRX configuration based on e.g. a flow being added or cancelled, or other alternatives as outlined above.

In step 830, the UE applies the DRX configuration based on the indication and receives the data traffic using the determined DRX configuration.

In the foregoing, general solutions and more detailed examples have been outlined, with reference to the drawings. Unless clearly contradictory, the features of any example provided herein may be combined in any way, including any combination of the items set out below.
Item 1. Method carried out in an access node of a wireless network for managing configuration of discontinuous reception, DRX, for a user equipment, UE, wherein the method comprises:
transmitting (710), to the UE, radio configuration information for a plurality of different DRX configurations;
obtaining (720) traffic information indicative of data traffic intended for the UE;
transmitting (730), to the UE, an indication of determined DRX configuration, identifying at least one of said plurality of different DRX configurations based on the traffic information;
conveying (740) the data traffic to the UE based on the determined DRX configuration.
Item 2. The method of item 1, wherein transmitting the indication of the determined DRX configuration is carried out by a lower layer control command.
Item 3. The method of item 2, wherein the indication of the determined DRX configuration is transmitted in a medium access control, MAC, control element, CE.
Item 4. The method of item 2, wherein the indication of the determined DRX configuration is transmitted in downlink control information, DCI.
Item 5. The method of any preceding item, wherein the radio configuration information is transmitted in a radio resource control, RRC, message.
Item 6. The method of any preceding item, wherein the determined DRX configuration identifies multiple DRX configurations comprising a first DRX cycle and an associated first On duration, and a second DRX cycle and an associated second On duration.
Item 7. The method of item 6, wherein the second DRX cycle is different from the first DRX cycle.
Item 8. The method of item 6 or 7, wherein the UE is configured to apply an offset with regard to a reference point, which offset identifies a time shift between a start of an occasion of the second On duration with respect to an occasion of the first On duration.
Item 9. The method of item 8, wherein said offset is shorter than the first DRX cycle.
Item 10. The method of any of items 6-9, wherein said reference point identifies a system frame number, SFN.
Item 11. The method of any of items 6-9, wherein said reference point identifies a start of the first On duration.
Item 12. The method of any preceding item, wherein the traffic information identifies the determined DRX configuration.
Item 13. The method of any preceding item, wherein the traffic information comprises data flow information of said data traffic, wherein said data flow information identifies at least frame rate of one or more data flows.
Item 14. The method of item 13, further comprising:
determining one of said plurality of different DRX configurations based on the data flow information.
Item 15. The method of any preceding item, wherein the traffic information comprises application information of said data traffic.
Item 16. The method of item 15, further comprising:
determining one of said plurality of different DRX configurations based on the application information.
Item 17. The method of any preceding item, wherein the traffic information comprises an ID associated with the UE, wherein the determined DRX configuration is determined dependent on the ID.
Item 18. The method of any preceding item, wherein obtaining traffic information comprises receiving the traffic information from the UE.
Item 19. The method of any preceding item, comprising:
obtaining capability information associated with the UEs capability to operate different DRX configurations; and
reporting the capability information to a core network node.
Item 20. The method of any preceding item, comprising:
receiving, from the UE, channel quality information,
wherein the determined DRX configuration is determined dependent on the channel quality information.
Item 21. The method of any preceding item, comprising:
determining a change of traffic information associated with the data traffic;
transmitting, to the UE, an update message associated with the determined DRX configuration.
Item 22. The method of item 21, wherein the update message comprises a new determined DRX configuration or a temporary always On indication.
Item 23. An access node (121) of a wireless network (100), comprising:
a transceiver (313) for wireless communication with a user equipment, UE (10); and
logic circuitry (310) configured to control the access node to carry out the method of any of items 1-21 for managing discontinuous reception, DRX, configuration for the UE.
Item 24. Method carried out in a user equipment, UE, for managing discontinuous reception, DRX, configuration, wherein the method comprises:
receiving (810), from an access node of a wireless network, radio configuration information for a plurality of different DRX configurations;
receiving (820), from the access node, an indication of a determined DRX configuration, identifying at least one of said plurality of different DRX configurations based on traffic information indicative of data traffic intended for the UE;
receiving (830) the data traffic using the determined DRX configuration.
Item 25. The method of item 24, wherein the indication of the determined DRX configuration is received in a lower layer control command.
Item 26. The method of item 25, wherein the indication of the determined DRX configuration is received in a medium access control, MAC, control element, CE.
Item 27. The method of item 25, wherein the indication of the determined DRX configuration is received in downlink control information, DCI.
Item 28. The method of any of items 25-27, wherein the radio configuration information is received in a radio resource control, RRC, message.
Item 29. The method of any of items 24-28,
wherein the determined DRX configuration identifies multiple DRX configurations comprising a first DRX cycle and an associated first On duration, and a second DRX cycle and an associated second On duration.
Item 30. The method of item 29,
wherein the second DRX cycle is different from the first DRX cycle.
Item 31. The method of item 29 or 30, further comprising:
applying an offset with regard to a reference point, which offset identifies a time shift between a start of an occasion of the second On duration with respect to an occasion of the first On duration
Item 32. The method of item 31,
wherein said offset is shorter than the first DRX cycle.
Item 33. The method of any of items 29-32, wherein said reference point identifies a system frame number, SFN.
Item 34. The method of any of items 29-33, wherein said reference point identifies a start of the first On duration.
Item 35. The method of any of items 24-34, comprising:
transmitting, to the wireless network, capability information associated with the UE's capability to operate different DRX configurations.
Item 36. The method of any of items 24-35, comprising:
transmitting, to the access node, channel quality information, wherein the determined DRX configuration is determined dependent on the channel quality information.
Item 37. The method of any of items 24-36, comprising:
receiving, from the access node, an update message associated with the determined DRX configuration based on a change of traffic information associated with the data traffic.
Item 38. The method of item 37, wherein the update message comprises a new determined DRX configuration or a temporary always On indication.
Item 39. The method of any of items 24-38, comprising:
obtaining information associated with the data traffic intended for the UE;
transmitting, to the access node, the traffic information based on the obtained information.
Item 40. The method of item 39, wherein the traffic information identifies one of: an identification of an application, data related to flows of the traffic data, a preferred DRX configuration to apply for receiving the data traffic.
Item 41. A user equipment, UE (10), comprising:
a transceiver (213) for wireless communication with a wireless network (100); and
logic circuitry (210) configured to control the UE to carry out the method of any of items 24-40 for managing discontinuous reception, DRX, configuration.

1. A method carried out in an access node of a wireless network for managing configuration of discontinuous reception (DRX) for a user equipment (UE) wherein the method comprises:
transmitting, to the UE, radio configuration information for a plurality of different DRX configurations;
obtaining traffic information indicative of data traffic intended for the UE;
transmitting, to the UE, an indication of determined DRX configuration, identifying at least one of said plurality of different DRX configurations based on the traffic information;
conveying the data traffic to the UE based on the determined DRX configuration.

2. The method of claim 1, wherein transmitting the indication of the determined DRX configuration is carried out by a lower layer control command.

3. The method of claim 2, wherein the indication of the determined DRX configuration is transmitted in a medium access control (MAC) control element (CE).

4. The method of claim 2, wherein the indication of the determined DRX configuration is transmitted in downlink control information (DCI).

5. The method of claim 1, wherein the radio configuration information is transmitted in a radio resource control (RRC) message.

6. The method of claim 1, wherein the determined DRX configuration identifies multiple DRX configurations comprising a first DRX cycle and an associated first On duration, and a second DRX cycle and an associated second On duration.

7. The method of claim 6, wherein the second DRX cycle is different from the first DRX cycle.

8. The method of claim 6, wherein the UE is configured to apply an offset with regard to a reference point, which offset identifies a time shift between a start of an occasion of the second On duration with respect to an occasion of the first On duration.

9. The method of claim 8, wherein said offset is shorter than the first DRX cycle.

10. The method of claim 6, wherein said reference point identifies a system frame number (SFN).

11. The method of claim 6, wherein said reference point identifies a start of the first On duration.

12. The method of claim 1, wherein the traffic information identifies the determined DRX configuration.

13. The method of claim 1, wherein the traffic information comprises data flow information of said data traffic, wherein said data flow information identifies at least frame rate of one or more data flows.

14. The method of claim 13, further comprising:
determining one of said plurality of different DRX configurations based on the data flow information.

15. The method of claim 1, wherein the traffic information comprises application information of said data traffic.

16. The method of claim 15, further comprising:
determining one of said plurality of different DRX configurations based on the application information.

17. The method of claim 1, wherein the traffic information comprises an ID associated with the UE, wherein the determined DRX configuration is determined dependent on the ID.

18. The method of claim 1, wherein obtaining traffic information comprises receiving the traffic information from the UE.

19. The method of claim 1, comprising:
obtaining capability information associated with the UEs capability to operate different DRX configurations; and
reporting the capability information to a core network node.

20-23. (canceled)

24. A method carried out in a user equipment (UE) for managing discontinuous reception (DRX) configuration, wherein the method comprises:
receiving, from an access node of a wireless network, radio configuration information for a plurality of different DRX configurations;
receiving, from the access node, an indication of a determined DRX configuration, identifying at least one of said plurality of different DRX configurations based on traffic information indicative of data traffic intended for the UE;
receiving the data traffic using the determined DRX configuration.

25-41.
